(19) United States
(12) Patent Application Publication
(10) Pub. No.: US 2023/0125040 A1
(43) Pub. Date: Apr. 20, 2023

(54) Temporally Consistent Neural Network Processing System

(71) Applicant: Spectrum Optix Inc., Vancouver (CA)

(72) Inventors: Timothy James Put, Edmonton (CA); Colin Thomas D'Amore, Edmonton (CA); Kevin Taylor Gordon, Calgary (CA)

(21) Appl. No.: 17/964,566

(22) Filed: Oct. 12, 2022

Related U.S. Application Data
(60) Provisional application No. 63/255,644, filed on Oct. 14, 2021.

(51) Int. Cl. G06T 5/00; G06T 7/20

(52) U.S. Cl. CPC G06T 5/002; G06T 7/20; G06T 2207/20084; G06T 2207/20182

(57) ABSTRACT

An image processing pipeline including a still or video camera includes an image processing system having a first neural network arranged to receive at least one input image from a video camera having noise features and feedback from a neural embedding. The neural network processes at least one input image and feedback from the neural embedding to provide a temporally consistent output image having reduced noise as compared to noise features in the at least one input image. In some embodiments a second neural network in the image processing system is arranged to modify at least one of an image capture setting, sensor processing, global post processing, local post processing, portfolio post processing, or provide latent vectors or neural embedding information.

### RELATED APPLICATION

This application claims the benefit of U.S. Provisional Application Ser. No. 63/255,644, filed Oct. 14, 2021, and entitled TEMPORALLY CONSISTENT NEURAL NETWORK PROCESSING SYSTEM, which is hereby incorporated by reference in its entirety.

### TECHNICAL FIELD

The present disclosure relates to systems for improving images using neural network processing techniques that utilize information from multiple related images to improve appearance of selected images or video frames. In particular, described is a method and system using neural networks that input multiple images or video frames to provide one or more temporally consistent images.

### BACKGROUND

Digital image or video cameras typically require a digital image processing pipeline that converts signals received by an image sensor into a usable low noise image. Using various specialized algorithms, corrections can be made either on-board a camera, or later in post-processing of RAW images. However, many of these algorithms are proprietary, difficult to modify, or require substantial amounts of skilled user work for best results.

Conventional neural networks can be used to provide noise or other types of image corrections. However, widespread use of neural networks and algorithms is often impractical due limited available processing power, high dimensionality of a problem, time limitations, or absence of useful training sets. Methods and systems that can improve image processing, reduce user work, and allow updating and improvement are needed.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates a neural network that utilizes multiple frame processing to provide temporally consistent images;

FIG. 1B illustrates a neural network that utilizes recurrent frame processing to provide temporally consistent images;

FIG. 1C illustrates a neural network that utilizes recurrent neural embedding processing to provide temporally consistent images;

FIG. 1D illustrates a neural network supported image or video processing pipeline that provides temporally consistent images;

FIG. 1E illustrates a neural network supported image or video processing system that provides temporally consistent images;

FIG. 1F is another embodiment illustrating a neural network supported software system that provides temporally consistent images;

FIG. 2 illustrates a system with control, imaging, and display sub-systems; and

FIG. 3 illustrates one example of neural network processing of RGB images that provides temporally consistent images.

### DETAILED DESCRIPTION

In some of the following described embodiments, methods, processing schemes, and systems for improving neural network processing are described. In particular, neural network processing embodiments that increase temporal consistency between frames of in video streams are described. Temporal consistency (or alternatively, temporal stability) can be considered to be an index of the retest reliability of an instrument. An instrument that is temporally consistent has no substantial change when being tested multiple times under the same conditions or scenario. In camera sensors, noise can introduce errors into recorded values, making them less temporally consistent as the amount of noise increases. Since noise can be treated as is independent for each frame, incorporating temporal (time related) information into neural network processing can allow use of noise data in multiple frames. This allows neural networks to better achieve overall denoising and provide more temporally consistent video streams. In effect, such methods, processing schemes, or system embodiments can reduce visual artifacts due to noise or other multiple frame inconsistencies.

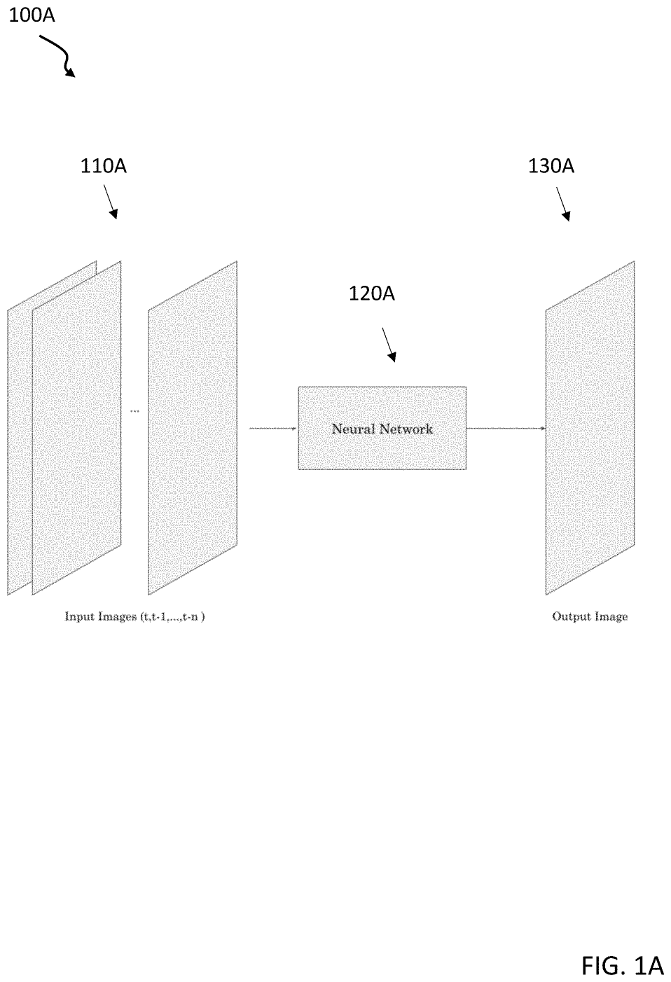

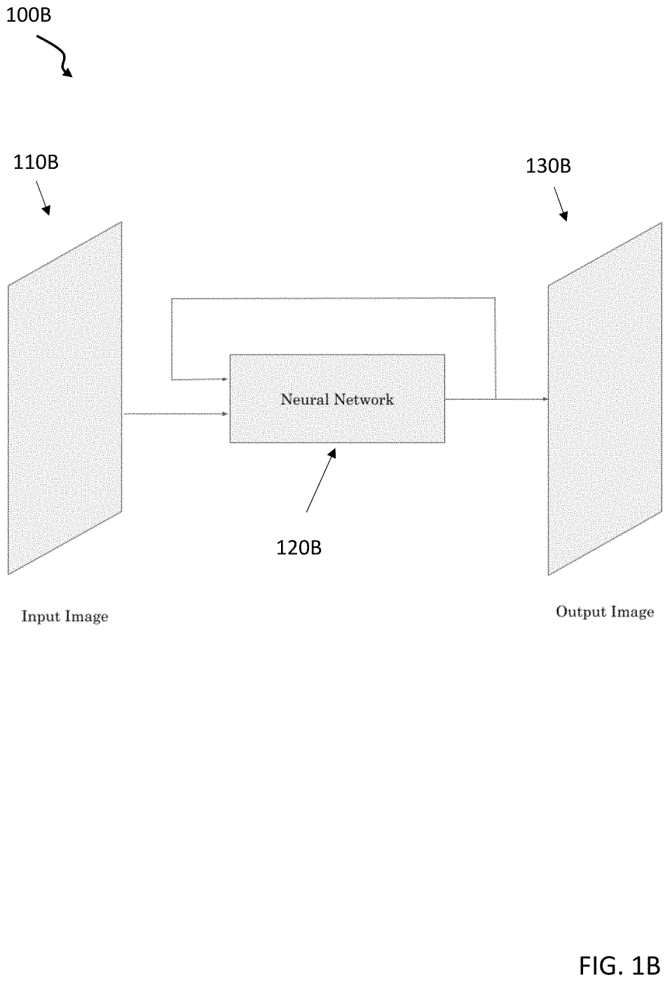

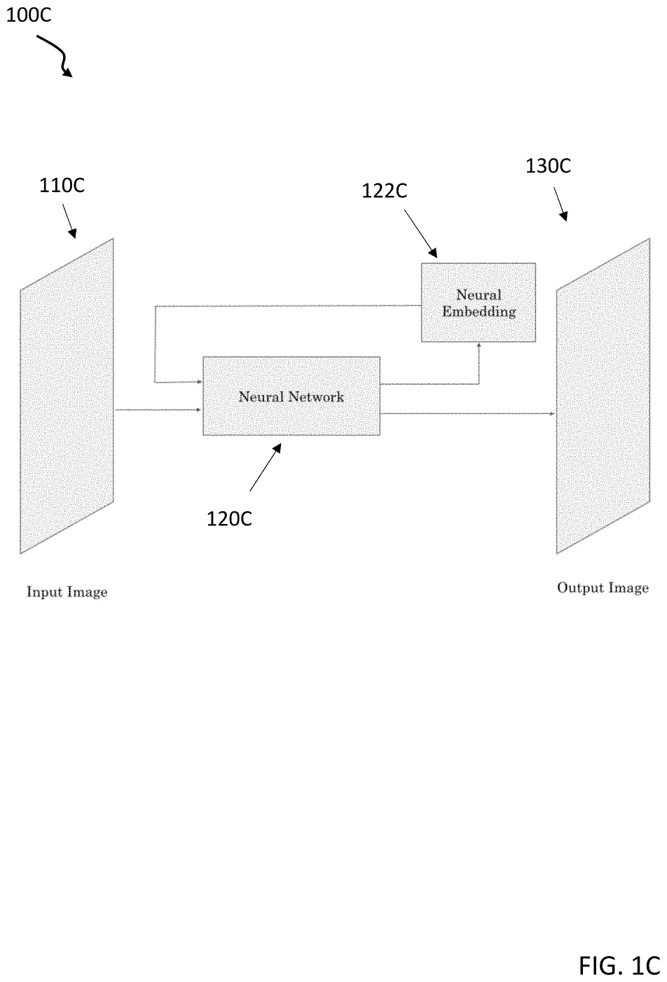

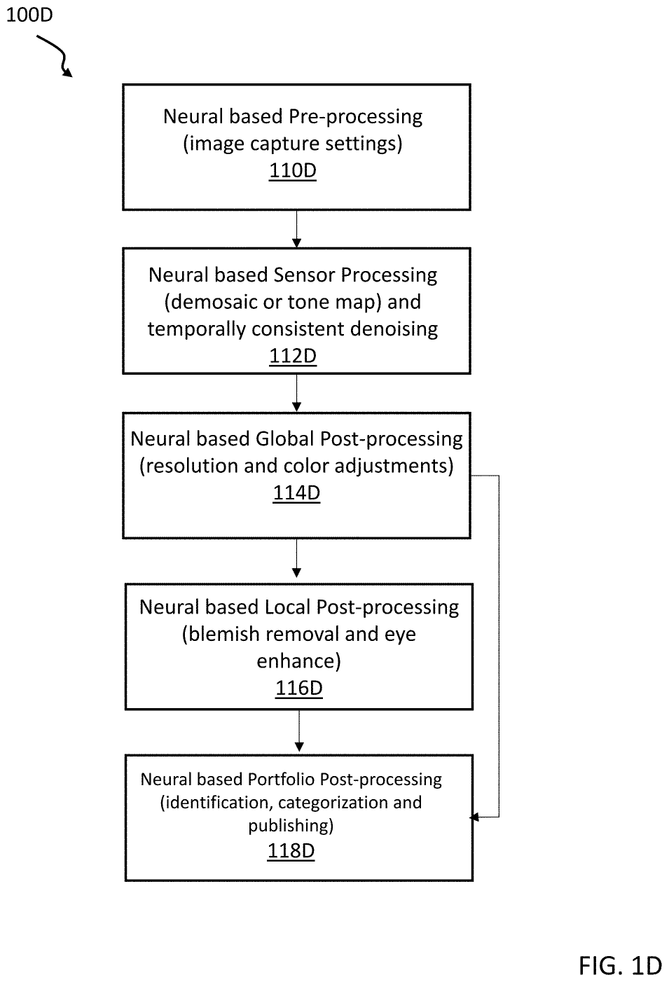

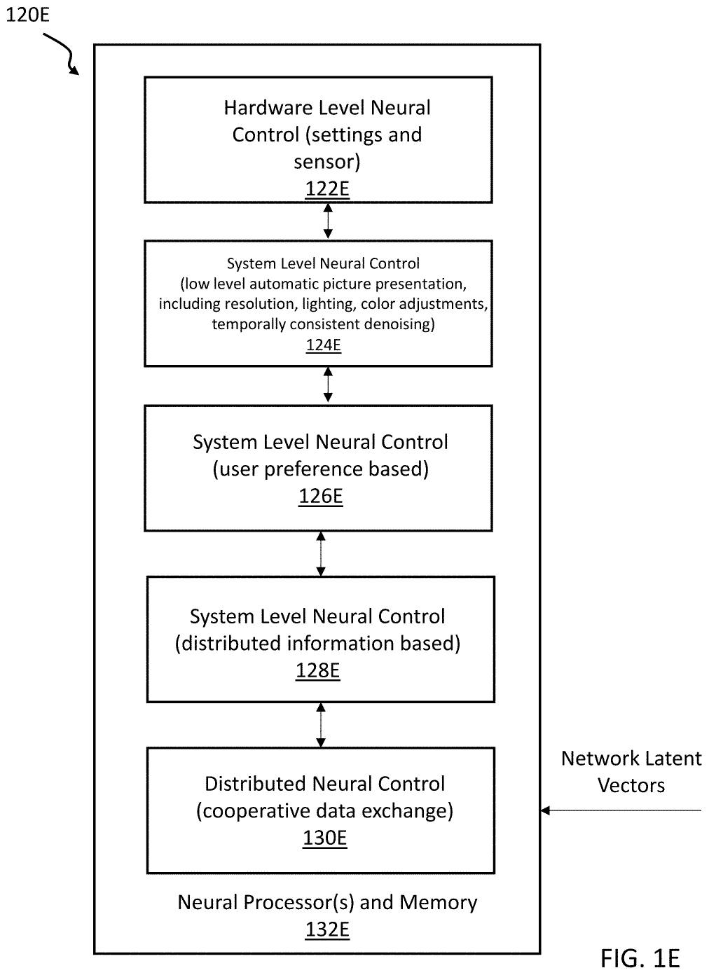

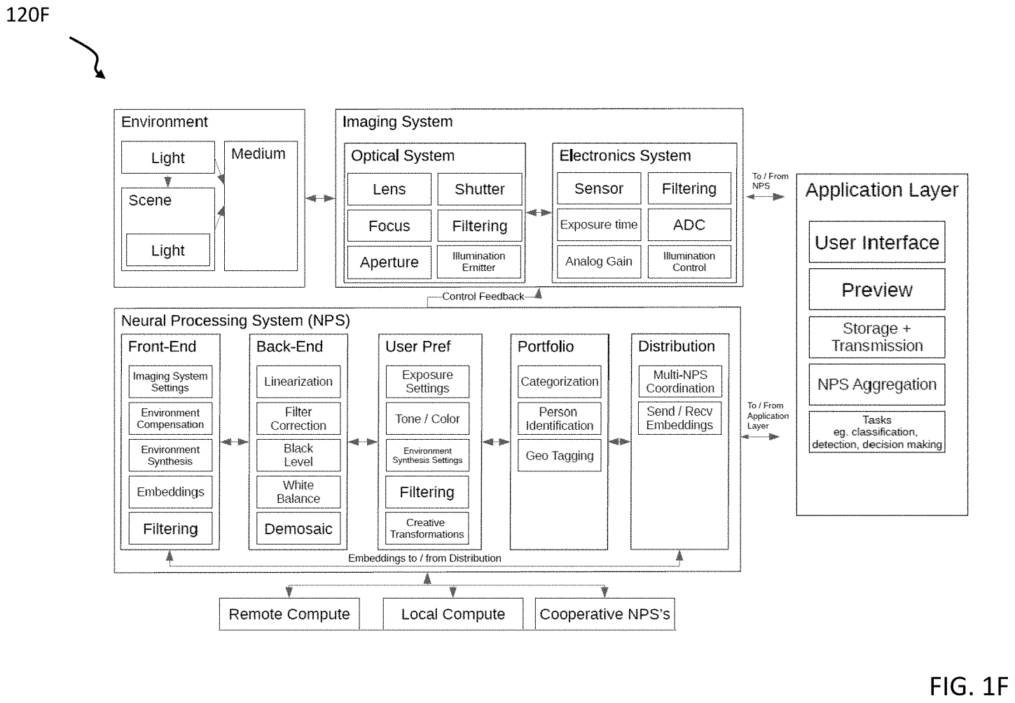

FIG. 1A illustrates a neural network method or system that utilizes multiple frame processing to provide temporally consistent images. As illustrated, a system or method 100A uses as input 110A multiple frames into a neural network 120A, and outputs 130A denoised and temporally consistent images. The input frames can include frames t, t−1, . . . , t−n where t represents the most recent frame from the video stream and n is the number of frames input into the neural network 120A. The output image represents a denoised and temporally consistent version of frame t. In some embodiments, the network can be trained to disregard major changes in the frequency domain when comparing frame t to previous frames in a video stream. In effect, the more motion in the video stream in the last n frames, the less relevant these frames will be to the neural network 120A and the output image.

FIG. 1B illustrates a neural network method or system that utilizes recurrent frame processing to provide temporally consistent images. As illustrated, a system or method 100B has inputs 110B that includes an input image into a neural network 120B, and outputs 130B of a denoised and temporally consistent images. In this embodiment, inputs can include both a most recent frame from a video stream (110B) and the neural network outputs (130B) from the previous frame to provide denoised and temporally consistent versions of the input images. In effect, by using the already existing denoised output from previous frames, it is much easier for the network to disregard major changes in the frequency domain and denoise the current frame. The more the previous image frame differs from the current frame in the frequency domain, the less use the previous network output will be to the network when predicting the output to the next frame.

FIG. 1C illustrates a neural network method or system that utilizes recurrent neural embedding processing to provide temporally consistent images. As illustrated, a system or method 100C has input 110C that includes an input image into a neural network 120C, and output 130C of a single denoised and temporally consistent image. In this embodiment, inputs can include both a most recent frame from a video stream (110C) and a neural embedding (122C) using information derived at least in part from the previous frame. Input 110C of a most recent frame from the video stream and the neural embedding 122C allow for output of a denoised and temporally consistent version of the input image. The neural embedding 122C includes an encoded latent vector which contains compressed information about the previous frame. This helps the network utilize information from the previous frame and predict the succeeding frame. Using neural embedding, dimensionality of a processing problem can be reduced and image processing speed can be greatly improved. Neural embedding provides a mapping of a high dimensional image to a position on a low-dimensional manifold represented by a vector (“latent vector”). Components of the latent vector learn continuous representations that may be constrained to represent specific discrete variables. In some embodiments a neural embedding can be a mapping of a discrete variable to a vector of continuous numbers, providing low-dimensional, learned continuous vector representations of discrete variables.

FIG. 1D illustrates one embodiment of a neural network supported image or video processing pipeline system and method 100D. This pipeline 100D can use one or more neural networks at multiple points in the image processing pipeline. For example, neural network-based image pre-processing that occurs before image capture (step 110D) can include optional use of neural networks to select one or more of ISO, focus, exposure, resolution, image capture moment (e.g. when eyes are open) or other image or video settings. In addition to using a neural network to simply select reasonable image or video settings, such analog and pre-image capture factors can be automatically adjusted or adjusted to favor factors that will improve efficacy of later neural network processing. For example, flash or other scene lighting can be increased in intensity, duration, or redirected. Filters can be removed from an optical path, apertures opened wider, or shutter speed decreased. Image sensor efficiency or amplification can be adjusted by ISO selection, all with a view toward (for example) improved neural network color adjustments or HDR processing.

After image capture, neural network based sensor processing (step 112D) can be used to provide custom demosaic, tone maps, dehazing, pixel failure compensation, or dust removal. Other neural network based processing can include Bayer color filter array correction, colorspace conversion, black and white level adjustment, or other sensor related processing. Still other neural network processing can include denoising or other video improvement through use of multiple frame processing, recurrent frame processing, or recurrent neural embedding processing such as respectively described with respect to FIG. 1A, 1B, or 1C.

Optional neural network based global post processing (step 114D) can include resolution or color adjustments, as well as stacked focus or HDR processing. Other global post processing features can include HDR in-filling, bokeh adjustments, super-resolution, vibrancy, saturation, color enhancements, and tint or IR removal.

Optional neural network based local post processing (step 116D) can include red-eye removal, blemish removal, dark circle removal, blue sky enhancement, green foliage enhancement, or other processing of local portions, sections, objects, or areas of an image. Identification of the specific local area can involve use of other neural network assisted functionality, including for example, a face or eye detector.

Optional neural network based portfolio post processing (step 116D) can include image or video processing steps related to identification, categorization, or publishing. For example, neural networks can be used to identify a person and provide that information for metadata tagging. Other examples can include use of neural networks for categorization into categories such as pet pictures, landscapes, or portraits.

FIG. 1E illustrates a neural network supported image or video processing system 120E. In one embodiment, hardware level neural control module 122E (including settings and sensors) can be used to support processing, memory access, data transfer, and other low level computing activities. A system level neural control module 124E interacts with hardware module 122E and provides preliminary or required low level automatic picture presentation tools, including determining useful or needed resolution, or lighting or color adjustments. Other neural network processing can include denoising or other video improvement through use of multiple frame processing, recurrent frame processing, or recurrent neural embedding processing such as respectively described with respect to FIG. 1A, 1B, or 1C. Images or video can be processed using a system level neural control module 126E that can include user preference settings, historical user settings, or other neural network processing settings based on third party information or preferences. A system level neural control module 128E can also include third party information and preferences, as well as settings to determine whether local, remote, or distributed neural network processing is needed. In some embodiments, a distributed neural control module 130E can be used for cooperative data exchange. For example, as social network communities change styles of preferred portraits images (e.g. from hard focus styles to soft focus), portrait mode neural network processing can be adjusted as well. This information can be transmitted to any of the various disclosed modules using network latent vectors, provided training sets, or mode related setting recommendations.

In some embodiments, redundant information related to global or local motion in a video can be used to improve video processing throughput and efficiency. For example, denoising and temporally consistent video methods such as described herein are prone to create visual artifacts such as ghosting when applied to moving regions. Techniques are needed to identify motion and prevent application of denoising and temporally consistent video algorithms for those identified moving regions. For example, to identify motion, change in pixel intensities between frames can be measured while compensating for noise and illumination changes. Alternatively or in addition, a CNN can be used predict which pixels have changed as a result of motion by providing frames t and t−1. Only non-moving regions or images are subject to use of the described denoising and temporally consistent video methods.

In other embodiments, various additional algorithms can be used to improve motion models or provide motion compensation. For example, global motion can be estimated using an image represented at multiple scales to perform coarse-to-fine motion estimation. One such multi-scale image representation is the image pyramid (e.g. gaussian, pyramids, laplacian pyramids). In practice, an image is downsampled iteratively until the desired number of resolutions are represented, and grid-search or other motion estimation is performed—first at the lowest resolution and then to progressively higher resolutions, with the output of the previous resolution's matching results feeding into the current matching process to reduce search space.

Improved motion models can also include local motion in some embodiments. An image can be decomposed into the image into regions of consistent motion. An estimate of local motion for each moving region can be done independently using the same or similar techniques as that discussed with respect to global motion.

In some embodiments a CNN can be used to predict not just whether a pixel has experienced motion, but also to classify that motion into one of several ‘motion groups’. Each CNN identified motion group would normally existent consistent motion distinct from global motion and can be compensated for independently.

In some embodiments, computational load can be reduced by taking advantage of motion estimates available in many commonly encoded video formats, including the various HEVC and MPEG related encoders. Motion vectors stored in a compressed video stream can be used to assist in quantifying motion in a video.

FIG. 1F is another embodiment illustrating a neural network supported software system 120F. As shown, information about an environment, including light, scene, and capture medium is detected and potentially changed, for example, by control of external lighting systems or on camera flash systems. An imaging system that includes optical and electronics subsystems can interact with a neural processing system and a software application layer. In some embodiments, remote, local or cooperative neural processing systems can be used to provide information related to settings and neural network processing conditions.

In more detail, the imaging system can include an optical system that is controlled and interacts with an electronics system. The optical system contains optical hardware such as lenses and an illumination emitter, as well electronic, software or hardware controllers of shutter, focus, filtering and aperture. The electronics system includes a sensor and other electronic, software or hardware controllers that provide filtering, set exposure time, provide analog to digital conversion (ADC), provide analog gain, and act as an illumination controller. Data from the imaging system can be sent to the application layer for further processing and distribution and control feedback can be provided to a neural processing system (NPS).

The neural processing system can include a front-end module, a back-end module, user preference settings, portfolio module, and data distribution module. Computation for modules can be remote, local, or through multiple cooperative neural processing systems either local or remote. The neural processing system can send and receive data to the application layer and the imaging system.

In the illustrated embodiment, the front-end includes settings and control for the imaging system, environment compensation, environment synthesis, embeddings, and filtering. The back-end provides linearization, filter correction, black level set, white balance, and demosaic. Both the front-end or back-end neural network processing system can support temporally consistent denoising through use of multiple frame processing, recurrent frame processing, or recurrent neural embedding processing such as respectively described with respect to FIG. 1A, 1B, or 1C. User preferences can include exposure settings, tone and color settings, environment synthesis, filtering, and creative transformations. The portfolio module can receive this data and provide categorization, person identification, or geotagging. The distribution module can coordinate sending and receiving data from multiple neural processing systems and send and receive embeddings to the application layer. The application layer provides a user interface to custom settings, as well as image or setting result preview. Images or other data can be stored and transmitted, and information relating to neural processing systems can be aggregated for future use or to simplify classification, activity or object detection, or decision making tasks.

As will be understood, in addition to providing improved and/or denoised images through use of multiple frame processing, recurrent frame processing, or recurrent neural embedding processing, neural networks can be used to modify or control image capture settings in one or more processing steps that include exposure setting determination, RGB or Bayer filter processing, color saturation adjustment, red-eye reduction, or identifying picture categories such as owner selfies, or providing metadata tagging and internet mediated distribution assistance. Neural networks can be used to modify or control image capture settings in one or more processing steps that include denoising with or without temporal consistency features, color saturation adjustment, glare removal, red-eye reduction, and eye color filters. Neural networks can be used to modify or control image capture settings in one or more processing steps that can include but are not limited to the capture of multiple images, image selection from the multiple images, high dynamic range (HDR) processing, bright spot removal, and automatic classification and metadata tagging. Neural networks can be used to modify or control image capture settings in one or more processing steps that include video and audio setting selection, electronic frame stabilization, object centering, motion compensation, and video compression.

A wide range of still or video cameras can benefit from use neural network supported image or video processing pipeline system and method. Camera types can include but are not limited to conventional DSLRs with still or video capability, smartphone, tablet cameras, or laptop cameras, dedicated video cameras, webcams, or security cameras. In some embodiments, specialized cameras such as infrared cameras, thermal imagers, millimeter wave imaging systems, x-ray or other radiology imagers can be used. Embodiments can also include cameras with sensors capable of detecting infrared, ultraviolet, or other wavelengths to allow for hyperspectral image processing.

Cameras can be standalone, portable, or fixed systems. Typically, a camera includes processor, memory, image sensor, communication interfaces, camera optical and actuator system, and memory storage. The processor controls the overall operations of the camera, such as operating camera optical and sensor system, and available communication interfaces. The camera optical and sensor system controls the operations of the camera, such as exposure control for image captured at image sensor. Camera optical and sensor system may include a fixed lens system or an adjustable lens system (e.g., zoom and automatic focusing capabilities). Cameras can support memory storage systems such as removable memory cards, wired USB, or wireless data transfer systems.

In some embodiments, neural network processing can occur after transfer of image data to remote computational resources, including a dedicated neural network processing system, laptop, PC, server, or cloud. In other embodiments, neural network processing can occur within the camera, using optimized software, neural processing chips, dedicated ASICs, custom integrated circuits, or programmable FPGA systems.

In some embodiments, results of neural network processing can be used as an input to other machine learning or neural network systems, including those developed for object recognition, pattern recognition, face identification, image stabilization, robot or vehicle odometry and positioning, or tracking or targeting applications. Advantageously, such neural network processed image normalization can, for example, reduce computer vision algorithm failure in high noise environments, enabling these algorithms to work in environments where they would typically fail due to noise related reduction in feature confidence. Typically, this can include but is not limited to low light environments, foggy, dusty, or hazy environments, or environments subject to light flashing or light glare. In effect, image sensor noise is removed by neural network processing so that later learning algorithms have a reduced performance degradation.

In some embodiments, neural networks can be used in conjunction with neural network embeddings that reduce the dimensionality of categorical variables and represent categories in the transformed space. Neural embeddings are particularly useful for categorization, tracking, and matching, as well as allowing a simplified transfer of domain specific knowledge to new related domains without needing a complete retraining of a neural network. In some embodiments, neural embeddings can be provided for later use, for example by preserving a latent vector in image or video metadata to allow for optional later processing or improved response to image related queries. For example, a first portion of an image processing system can be arranged to reduce data dimensionality, effectively downsample an image, images, or other data, or provide denoising through temporally consistent neural processing techniques to provide neural embedding information. A second portion of the image processing system can also be arranged for at least one of categorization, tracking, and matching using neural embedding information derived from the neural processing system. Similarly, the neural network training system can include a first portion of a neural network algorithm arranged to reduce data dimensionality and effectively downsample an image or other data using a neural processing system to provide neural embedding information. A second portion of a neural network algorithm is arranged for at least one of categorization, tracking, and matching using neural embedding information derived from a neural processing system and a training procedure is used to optimize the first and second portions of the neural network algorithm.

In some embodiments, a training and inference system can include a classifier or other deep learning algorithms that can be combined with the neural embedding algorithm to create a new deep learning algorithm. The neural embedding algorithm can be configured such that its weights are trainable or non-trainable, but in either case will be fully differentiable such that the new algorithm is end-to-end trainable, permitting the new deep learning algorithm to be optimized directly from the objective function to the raw data input. During inference, the above-described algorithm can be partitioned such that the embedding algorithm executes on an edge or endpoint device, while other algorithms can execute on a centralized computing resource (cloud, server, gateway device).

In certain embodiments, multiple image sensors can collectively work in combination with the described neural network processing to enable wider operational and detection envelopes, with, for example, sensors having different light sensitivity working together to provide high dynamic range images. In other embodiments, a chain of optical or algorithmic imaging systems with separate neural network processing nodes can be coupled together. In still other embodiments, training of neural network systems can be decoupled from the imaging system as a whole, operating as embedded components associated with particular imagers.

In some embodiments, the described system can take advantage of bus mediated communication of neural network derived information, including a latent vector. For example, a multi-sensor processing system can operate to send information derived from one or more images and processed using a neural processing path for encoding. This latent vector, along with optional other image data or metadata can be sent over a communication bus or other suitable interconnect to a centralized processing module. In effect, this allows individual imaging systems to make use of neural embeddings to reduce bandwidth requirements of the communication bus, and subsequent processing requirements in the central processing module.

Bus mediation communication of neural networks can greatly reduce data transfer requirements and costs. For example, a city, venue, or sports arena IP-camera system can be configured so that each camera outputs latent vectors for a video feed. These latent vectors can supplement or entirely replace images sent to a central processing unit (eg. gateway, local server, VMS, etc). The received latent vectors can be used to perform video denoising through temporally consistent processing, provide analytics, or provided processed images combined with original video data to be presented to human operators. This allows performance of realtime analysis on hundreds or thousands of cameras, without needing access to a large data pipeline and a large and expensive server.

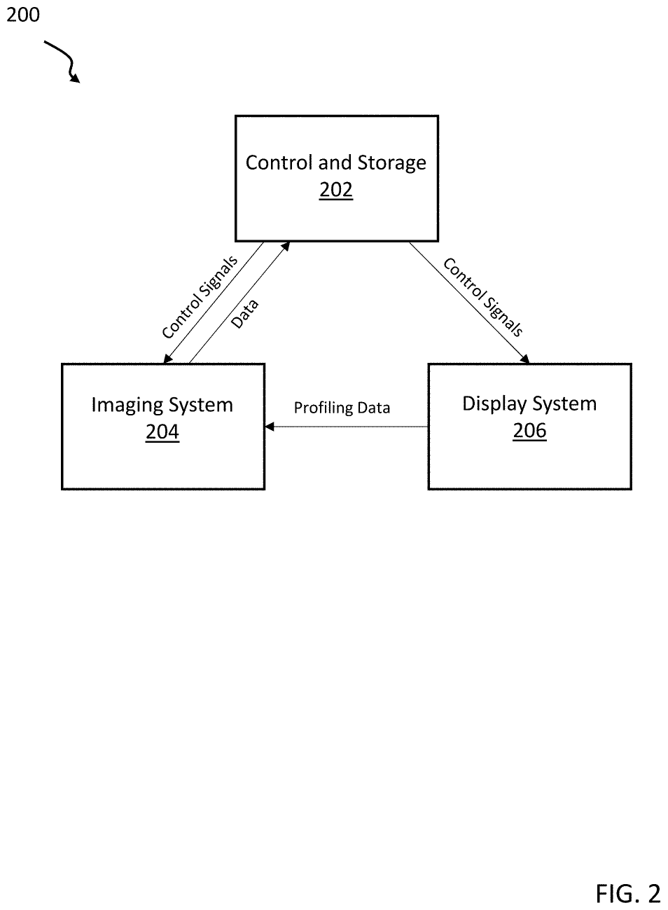

FIG. 2 generally describes hardware support for use and training of neural networks and image processing algorithms. In some embodiments, neural networks can be suitable for general analog and digital image processing. A control and storage module 202 able to send respective control signals to an imaging system 204 and a display system 206 is provided. The imaging system 204 can supply processed image data to the control and storage module 202, while also receiving profiling data from the display system 206. Training neural networks in a supervised or semi-supervised way requires high quality training data. To obtain such data, the system 200 provides automated imaging system profiling. The control and storage module 202 contains calibration and raw profiling data to be transmitted to the display system 206. Calibration data may contain, but is not limited to, targets for assessing resolution, focus, or dynamic range. Raw profiling data may contain, but is not limited to, natural and manmade scenes captured from a high quality imaging system (a reference system), and procedurally generated scenes (mathematically derived).

An example of a display system 206 is a high quality electronic display. The display can have its brightness adjusted or may be augmented with physical filtering elements such as neutral density filters. An alternative display system might comprise high quality reference prints or filtering elements, either to be used with front or back lit light sources. In any case, the purpose of the display system is to produce a variety of images, or sequence of images, to be transmitted to the imaging system.

The imaging system being profiled is integrated into the profiling system such that it can be programmatically controlled by the control and storage computer and can image the output of the display system. Camera parameters, such as aperture, exposure time, and analog gain, are varied and multiple exposures of a single displayed image are taken. The resulting exposures are transmitted to the control and storage computer and retained for training purposes. In some embodiments, the entire system is placed in a controlled lighting environment, such that the photon “noise floor” is known during profiling.

The entire system is setup such that the limiting resolution factor is the imaging system. This is achieved with mathematical models which take into account parameters, including but not limited to: imaging system sensor pixel pitch, display system pixel dimensions, imaging system focal length, imaging system working f-number, number of sensor pixels (horizontal and vertical), number of display system pixels (vertical and horizontal). In effect a particular sensor, sensor make or type, or class of sensors can be profiled to produce high-quality training data precisely tailored to individual sensors or sensor models.

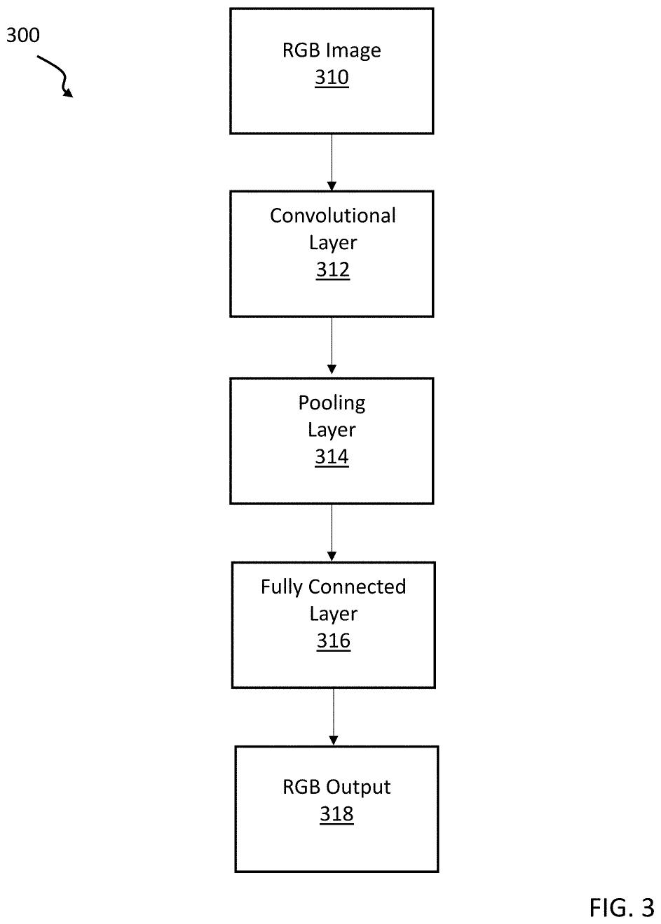

Various types of neural networks can be used with the systems disclosed with respect to FIGS A-F and FIG. 2, including fully convolutional, recurrent, generative adversarial, or deep convolutional networks. Convolutional neural networks are particularly useful for image processing applications such as described herein. As seen with respect to FIG. 3, a convolutional neural network 300 undertaking neural based sensor processing such as discussed with respect to FIG. 1A can receive a single underexposed RGB image 310 as input. RAW formats are preferred, but compressed JPG images can be used with some loss of quality. Images can be pre-processed with conventional pixel operations or can preferably be fed with minimal modifications into a trained convolutional neural network 300. Processing can proceed through one or more convolutional layers 312, pooling layer 314, a fully connected layer 316, and ends with RGB output 316 of the improved image. In operation, one or more convolutional layers apply a convolution operation to the RGB input, passing the result to the next layer(s). After convolution, local or global pooling layers can combine outputs into a single or small number of nodes in the next layer. Repeated convolutions, or convolution/pooling pairs are possible. After neural base sensor processing is complete, the RGB output can be passed to This RGB image can be passed to neural network based global post-processing for additional neural network based modifications.

One neural network embodiment of particular utility is a fully convolutional neural network. A fully convolutional neural network is composed of convolutional layers without any fully-connected layers usually found at the end of the network. Advantageously, fully convolutional neural networks are image size independent, with any size images being acceptable as input for training or bright spot image modification.

In some embodiments, neural network embeddings are useful because they can reduce the dimensionality of categorical variables and represent categories in the transformed space. Neural embeddings are particularly useful for categorization, tracking, and matching, as well as allowing a simplified transfer of domain specific knowledge to new related domains without needing a complete retraining of a neural network. In some embodiments, neural embeddings can be provided for later use, for example by preserving a latent vector in image or video metadata to allow for optional later processing or improved response to image related queries. For example, a first portion of an image processing system can be arranged to reduce data dimensionality and effectively downsample an image, images, or other data using a neural processing system to provide neural embedding information. A second portion of the image processing system can also be arranged for at least one of categorization, tracking, and matching using neural embedding information derived from the neural processing system. Similarly, neural network training system can include a first portion of a neural network algorithm arranged to reduce data dimensionality and effectively downsample an image or other data using a neural processing system to provide neural embedding information. A second portion of a neural network algorithm is arranged for at least one of categorization, tracking, and matching using neural embedding information derived from a neural processing system and a training procedure is used to optimize the first and second portions of the neural network algorithm.

As will be understood, the camera system and methods described herein can operate locally or in via connections to either a wired or wireless connect subsystem for interaction with devices such as servers, desktop computers, laptops, tablets, or smart phones. Data and control signals can be received, generated, or transported between varieties of external data sources, including wireless networks, personal area networks, cellular networks, the Internet, or cloud mediated data sources. In addition, sources of local data (e.g. a hard drive, solid state drive, flash memory, or any other suitable memory, including dynamic memory, such as SRAM or DRAM) that can allow for local data storage of user-specified preferences or protocols. In one particular embodiment, multiple communication systems can be provided. For example, a direct Wi-Fi connection (802.11b/g/n) can be used as well as a separate 4G cellular connection.

Connection to remote server embodiments may also be implemented in cloud computing environments. Cloud computing may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

The flow diagrams and block diagrams in the described Figures are intended to illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. An image processing pipeline, comprising:
an image processing system having a neural network arranged to receive multiple input images from a video camera having noise features; and wherein
the neural network processes the multiple input images to provide a temporally consistent output image having reduced noise as compared to noise features in each of the multiple input images.

2. An image processing pipeline, comprising:
an image processing system having a neural network arranged to receive at least one input image from a video camera having noise features and feedback from the neural network; and wherein
the neural network processes at least one input image and feedback from the neural network to provide a temporally consistent output image having reduced noise as compared to noise features the at least one input image.

3. An image processing pipeline, comprising:
a motion identification and estimation system that identifies at least one of global and local moving regions;
a neural network arranged to receive at least one input image from a video camera having noise features and feedback from a neural embedding; and wherein
using the motion identification and estimation system, the neural network processes non-moving portions of at least one input image using feedback from the neural embedding to provide a temporally consistent output image having reduced noise as compared to noise features in the at least one input image.

4. An image processing pipeline, comprising:
an image processing system having a first neural network arranged to receive at least one input image from a video camera having noise features and feedback from a neural embedding wherein the neural network processes at least one input image and feedback from the neural embedding to provide a temporally consistent output image having reduced noise as compared to noise features in the at least one input image; and
a second neural network in the image processing system arranged to modify at least one of an image capture setting, sensor processing, global post processing, local post processing, portfolio post processing, or provide latent vectors or neural embedding information.

5. The image processing pipeline of claim 4, wherein the neural embedding information includes a latent vector.

6. The image processing pipeline of claim 4, wherein the neural embedding information includes at least one latent vector that is sent between modules in the image processing system.

7. The image processing pipeline of claim 4, wherein the neural embedding includes at least one latent vector that is sent between one or more neural networks in the image processing system.
